(19) United States
(12) Patent Application Publication
(10) Pub. No.: US 2023/0118012 A1
(43) Pub. Date: Apr. 20, 2023

(54) VEHICLE LIGHTING ASSEMBLY AND LIGHTING METHOD

(71) Applicant: Ford Global Technologies, LLC, Dearborn, MI (US)

(72) Inventors: Zachery Wang, Royal Oak, MI (US); Arun Kumar, Farmington Hills, MI (US)

(21) Appl. No.: 17/506,027

(22) Filed: Oct. 20, 2021

(51) Int. Cl. F21S 43/237; F21S 43/247; F21S 43/241; F21S 43/14; F21S 43/19

(52) U.S. Cl. CPC F21S 43/237; F21S 43/14; F21S 43/19; F21S 43/241; F21S 43/247; F21Y 2115/10

(57) ABSTRACT

A vehicle lighting assembly includes a light pipe system having a first light pipe, a second light pipe, and a third light pipe; a light source that emits light; and a mixing zone portion that guides light from the light source into the first light pipe, the second light pipe, and the third light pipe.

### TECHNICAL FIELD

This disclosure relates generally to a lighting assembly for a vehicle and, more particularly, to a lighting assembly incorporating a light pipe system having at least three distinct light pipes.

### BACKGROUND

Vehicles include various types of lighting assemblies. Some lighting assemblies include a lens covering a light source. The lighting assemblies are illuminated when light from the light source moves from the lamp assembly through the lens. Lighting assemblies can include headlamps, tail lamps, side markers, etc. Side markers, in some examples, help to identify a vehicle’s presence, position, and direction of travel when viewed from an oblique angle. Side markers often have an amber color. Some lighting assemblies include a light pipe.

### SUMMARY

In some aspects, the techniques described herein relate to a vehicle lighting assembly, including: a light pipe system having a first light pipe, a second light pipe, and a third light pipe; a light source that emits light; and a mixing zone portion that guides light from the light source into the first light pipe, the second light pipe, and the third light pipe.

In some aspects, the techniques described herein relate to a vehicle lighting assembly, wherein the first light pipe, the second light pipe, and third light pipe of the light pipe system are different portions of a single, monolithic structure.

In some aspects, the techniques described herein relate to a vehicle lighting assembly, wherein the mixing zone portion is part of the single, monolithic structure.

In some aspects, the techniques described herein relate to a vehicle lighting assembly, wherein the light pipe system is a polymer-based material.

In some aspects, the techniques described herein relate to a vehicle lighting assembly, wherein the first light pipe, the second light pipe, and the third light pipe are molded together as a single unitary structure to provide the light pipe system.

In some aspects, the techniques described herein relate to a vehicle lighting assembly, wherein the first light pipe extends away from the mixing zone portion in a first direction, the second light pipe extends away from the mixing zone portion in a second direction, and the third light pipe extends away from the mixing zone portion in third direction, wherein the first direction, the second direction, and the third direction are each different directions.

In some aspects, the techniques described herein relate to a vehicle lighting assembly, further including a taillight assembly having the light pipe system, mixing zone portion, and the light source, the first light pipe extending along a vertical upper region of the taillight assembly, the second light pipe extending along a vertically central region of the taillight assembly, and the third light pipe extending along a vertically lower region of the taillight assembly.

In some aspects, the techniques described herein relate to a vehicle lighting assembly, wherein the first light pipe extends vertically upward from the mixing zone portion, the second light pipe extends horizontally from the mixing zone portion, and the third light pipe extends vertically downward from the mixing zone portion.

In some aspects, the techniques described herein relate to a vehicle lighting assembly, wherein the first light pipe, the second light pipe, and the third light pipe each taper downward where the first light pipe, the second light pipe, and the third light pipe each interface with the mixing zone portion.

In some aspects, the techniques described herein relate to a vehicle lighting assembly, wherein the light source is an exchangeable Light Emitting Diode module.

In some aspects, the techniques described herein relate to a vehicle lighting assembly, the light pipe provide a side marker for the vehicle.

In some aspects, the techniques described herein relate to a vehicle lighting method, including: directing light from a light source into a mixing zone portion of a light pipe assembly; and routing some of the light from the mixing zone portion into a first light pipe of the light pipe assembly, some of the light from the mixing zone portion into a second light pipe of the light pipe assembly, and some of the light from the mixing zone portion into a third light pipe of the light pipe assembly.

In some aspects, the techniques described herein relate to a vehicle lighting method, wherein the light pipe assembly is a single, monolithic structure.

In some aspects, the techniques described herein relate to a vehicle lighting method, wherein the light pipe assembly is a polymer-based material.

In some aspects, the techniques described herein relate to a vehicle lighting method, wherein the first light pipe extends from the mixing zone portion in a first direction, the second light pipe extends from the mixing zone portion in a second direction, and the third light pipe extends from the mixing zone portion in third direction, wherein the first direction, the second direction, and the third direction are each different directions.

In some aspects, the techniques described herein relate to a vehicle lighting method, further including, emitting light along a vertically upper region of a taillight from the first light pipe, emitting light along a vertically central region of the taillight using the second light pipe, and emitting light along a vertically lower region of the taillight using the third light pipe.

In some aspects, the techniques described herein relate to a vehicle lighting method, further including emitting light from the mixing zone portion vertically upward into the first light pipe, horizontally into the second light pipe, and vertically downward into the third light pipe.

In some aspects, the techniques described herein relate to a vehicle lighting method, further including molding together the first light pipe, the second light pipe, the third light pipe, and the mixing zone portion.

In some aspects, the techniques described herein relate to a vehicle lighting method, further including activating an exchangeable Light Emitting Diode module to provide the light from the light source. vehicle lighting assembly and lighting method

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a rearview of a portion of a vehicle incorporating a lighting assembly according to an exemplary embodiment of the present disclosure.

FIG. 2 illustrates a closeup front view of a lighting assembly shown in FIG. 1.

FIG. 3 illustrates a light pipe system from the assembly of FIG. 2.

FIG. 4 illustrates a closeup view of an area of the light pipe system of FIG. 3.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

This disclosure relates generally to a lighting assembly for a vehicle and, in particular, a lighting assembly having a light pipe system with three light pipes. The light pipes of the light pipe system can be formed together as a single monolithic structure.

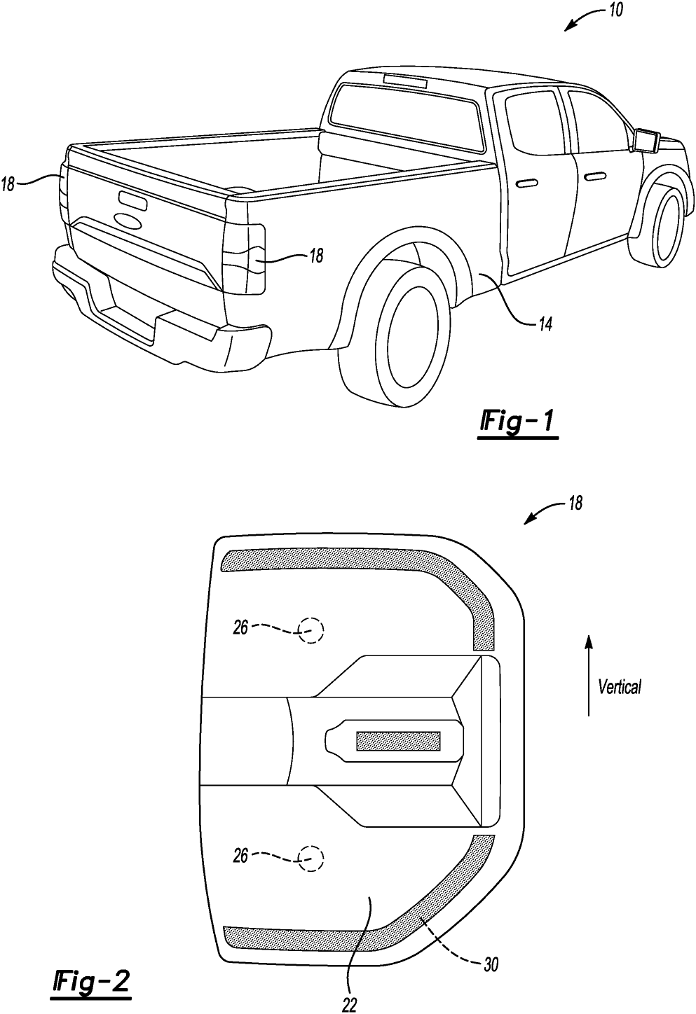

With reference to FIG. 1, a vehicle 10 includes a cargo bed 14 having at least one lighting assembly 18. In this example, the at least one lighting assembly 18 is a rear taillight assembly of the vehicle 10. Although the example lighting assembly 18 is a taillight, the teachings of this disclosure apply to other types of lighting assemblies, including other vehicle lighting assemblies such as headlights and interior lights.

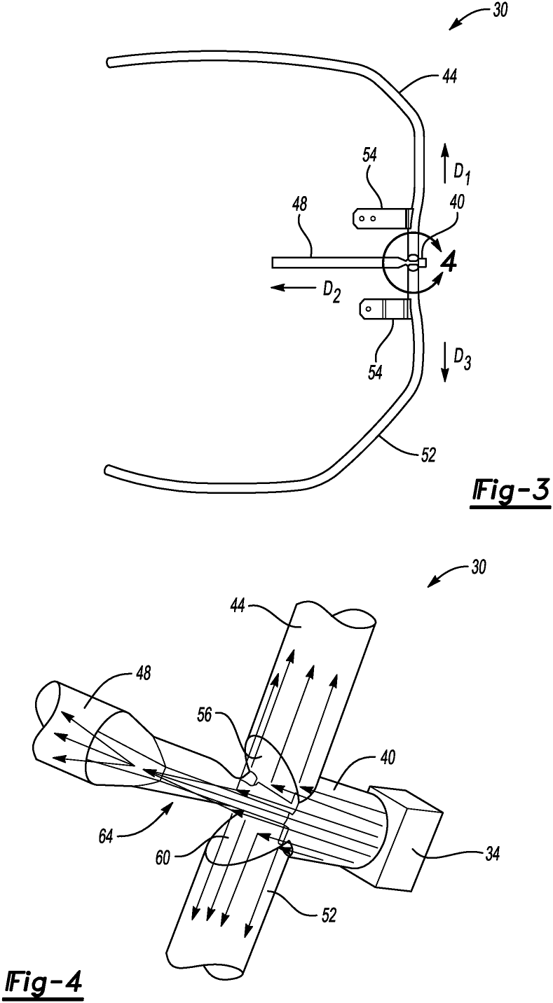

With reference now to FIGS. 2-4 and continuing reference , the lighting assembly 18 includes at least one lens 22, at least one light bulb 26, a light pipe system 30, and a light source 34 used in connection with the light pipe system 30.

The light pipe system 30 includes a mixing zone portion 40, a first light pipe 44, a second light pipe 48, and a third light pipe 52. The mixing zone portion 40 is positioned directly adjacent the light source 34 positioned relative to the light source 34.

The light pipe system 30 is a single monolithic structure. That is, the first light pipe 44, the second light pipe 48, and the third light pipe 52, and the mixing zone portion 40 are different portions of a single structure. The light pipe system 30 includes three light pipes. Other example light pipe systems could include more than three light pipes.

The mixing zone portion 40, the first light pipe 44, the second light pipe 48, and the third light pipe 52 can be molded together as a single, solid, unitary structure. The light pipe system 30 can be a polymer-based material, such as polycarbonate. The light pipe system 30 can be molded to include attachment tabs that are used to secure the light pipe system 30 within the lighting assembly 18.

The first light pipe 44, the second light pipe 48, and the third light pipe 52 branch from the mixing zone portion 40. In this example, the first light pipe 44 extends away from the mixing zone portion 40 in a first direction D1, the second light pipe 48 extends away from the mixing zone portion 40 in a second direction D2, and the third light pipe extends away from the mixing zone portion 40 in third direction D3. The first direction D1, the second direction D2, and the third direction D3 are each different directions.

More particularly, in the exemplary embodiment, the first light pipe 44 extends vertically upward from the mixing zone portion 40, the second light pipe 48 extends horizontally from the mixing zone portion 40, and the third light pipe 52 extends vertically downward from the mixing zone portion 40. Vertical, for purposes of this disclosure, is with reference to ground and an orientation of the lighting assembly 18 during ordinary operation of the vehicle. 10.

When installed within the lighting assembly 18, the first light pipe 44 extends along a vertical upper region of the lighting assembly 18, the second light pipe 48 extends along a vertically central region of the lighting assembly 18, and the third light pipe 52 extends along a vertically lower region of the lighting assembly 18.

The light source 34 is an exchangeable Light Emitting Diode module in the example embodiment. The light source 34 can include a plurality of individual Light Emitting Diodes.

The light source 34 can be selective activated to emit light. The activation can be in response to commands from a controller of a vehicle. The light from the light source 34 is directed into the mixing zone portion 40. From the mixing zone portion 40, the light is routed into the first light pipe 44, the second light pipe 48, and the third light pipe 52. The mixing zone portion 40 can guide the light from the light source 34 into the first light pipe 44, the second light pipe 48, or the third light pipe 52.

The first light pipe 44, the second light pipe 48, and the third light pipe 52 each taper downward where the first light pipe 44, the second light pipe 48, and the third light pipe 52 interface with the mixing zone portion 40. The tapering can facilitate the routing of the light from the mixing zone portion 40. Tapering downward, for purposes of this disclosure means that a diameter or dimension of the first light pipe 44, the second light pipe 48, or the third light pipe 52 is reduced as the light pipe system approaches the mixing zone portion 40.

More particularly, a face 56 of the first light pipe 44 and a face 60 of the third light pipe 52 are angled at approximately 45 degrees relative to the directions D1 and D3. The faces 56, 60 angled in this way can help to reroute light from the mixing zone portion 40 upward in the direction D1 into the first light pipe 44 and downward in the direction D3 into the third light pipe 52.

A tapered end portion 64 of the light pipe 48 interfaces within mixing zone portion 40 between the light pipe 44 and the light pipe 52. The tapered end portion 64 of the second light pipe 48 can help to fit the tapered end portion 64 of the light pipe 48 between the first light pipe 44 and the third light pipe 52. The angles and tapering of the first light pipe 44, the second light pipe 48, and the third light pipe 52 can be adjusted to route a desired about of light from the mixing zone portion 40.

The light emitted from the light pipe system 30 is visible through the lens 22 of the lighting assembly 18. The light from the light pipe system 30 can provide a side marker for the vehicle.

Some features of the disclosed examples include a light pipe system that can deliver from a single light source to at least three light pipes. The light is them emitted from the at least three light pipes with relatively consistent intensity. A single piece molded light pipe thus distributes nominally uniform light in at least three different directions with a single light source. Multiple light sources and separately molded light pipes are not required.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A vehicle lighting assembly, comprising:
a light pipe system having a first light pipe, a second light pipe, and a third light pipe;
a light source that emits light; and
a mixing zone portion that guides light from the light source into the first light pipe, the second light pipe, and the third light pipe, the mixing zone portion positioned directly adjacent the light source.

2. The vehicle lighting assembly of claim 1, wherein the first light pipe, the second light pipe, and third light pipe of the light pipe system are different portions of a single, monolithic structure.

3. The vehicle lighting assembly of claim 2, wherein the mixing zone portion is part of the single, monolithic structure.

4. (canceled)

5. The vehicle lighting assembly of claim 1, wherein the first light pipe, the second light pipe, the third light pipe, and the mixing zone portion are different portions of a single unitary structure to provide the light pipe system.

6. (canceled)

7. The vehicle lighting assembly of claim 1, further comprising a taillight assembly having the light pipe system, mixing zone portion, and the light source, the first light pipe extending along a vertical upper region of the taillight assembly, the second light pipe extending along a vertically central region of the taillight assembly, and the third light pipe extending along a vertically lower region of the taillight assembly.

8. The vehicle lighting assembly of claim 7, wherein the first light pipe extends vertically upward from the mixing zone portion, the second light pipe extends horizontally from the mixing zone portion, and the third light pipe extends vertically downward from the mixing zone portion.

9. The vehicle lighting assembly of claim 1, wherein the first light pipe, the second light pipe, and the third light pipe each taper downward where the first light pipe, the second light pipe, and the third light pipe each interface with the mixing zone portion.

10. The vehicle lighting assembly of claim 1, wherein the light source is an Light Emitting Diode module.

11. (canceled)

12. A vehicle lighting method, comprising:
directing light from a light source directly into a mixing zone portion of a light pipe assembly; and
routing some of the light from the mixing zone portion into a first light pipe of the light pipe assembly, some of the light from the mixing zone portion into a second light pipe of the light pipe assembly, and some of the light from the mixing zone portion into a third light pipe of the light pipe assembly.

13. The vehicle lighting method of claim 12, wherein the light pipe assembly is a single, monolithic structure.

14. The vehicle lighting method of claim 12, wherein the light pipe assembly is a polymer-based material.

15. The vehicle lighting method of claim 12, wherein the first light pipe extends from the mixing zone portion in a first direction, the second light pipe extends from the mixing zone portion in a second direction, and the third light pipe extends from the mixing zone portion in third direction, wherein the first direction, the second direction, and the third direction are each different directions.

16. The vehicle lighting method of claim 15, further comprising, emitting light along a vertically upper region of a taillight from the first light pipe, emitting light along a vertically central region of the taillight using the second light pipe, and emitting light along a vertically lower region of the taillight using the third light pipe.

17. The vehicle lighting method of claim 16, further comprising emitting light from the mixing zone portion vertically upward into the first light pipe, horizontally into the second light pipe, and vertically downward into the third light pipe.

18. The vehicle lighting method of claim 12, further comprising molding together the first light pipe, the second light pipe, the third light pipe, and the mixing zone portion.

19. The vehicle lighting method of claim 12, further comprising activating an Light Emitting Diode module to provide the light from the light source.

20. The vehicle lighting assembly of claim 1, wherein the mixing zone portion is configured to receive light from no more than one light source.

21. The vehicle lighting assembly of claim 1, further comprising an attachment tab extending from the first light pipe, the attachment tab used to secure the light pipe system, the first light pipe extending from the mixing zone portion past the attachment tab.

22. The vehicle lighting method of claim 12, wherein the mixing zone portion is configured to receive light from no more than one light source.

23. The vehicle lighting method of claim 12, further comprising securing the light pipe assembly using an attachment tab extending from the first light pipe, and still further comprising emitting light from the first light pipe at a position past where the attachment tab extends from the first light pipe.
